(19) United States
(12) Patent Application Publication
(10) Pub. No.: US 2018/0159576 A1
(43) Pub. Date: Jun. 7, 2018

(54) COMMUNICATION DEVICE AND CONTROL METHOD THEREOF

(71) Applicant: INDUSTRIAL TECHNOLOGY RESEARCH INSTITUTE, Hsinchu (TW)

(72) Inventors: Hung-Cheng CHANG, Taoyuan City (TW); Ping-Fan HO, Hsinchu County (TW); Jyh-Cheng CHEN, Taichung City (TW)

(73) Assignee: INDUSTRIAL TECHNOLOGY RESEARCH INSTITUTE, Hsinchu (TW)

(21) Appl. No.: 15/387,601

(22) Filed: Dec. 21, 2016

(30) Foreign Application Priority Data
Dec. 2, 2016 (TW) 105140002

(51) Int. Cl. H04B 1/3822; H04W 4/02

(52) U.S. Cl. CPC H04B 1/3822; H04W 4/025

(57) ABSTRACT

A communication device and a control method thereof are applied to a movable apparatus. The communication device includes a number of directional signal transceivers and a processor wherein aiming directions of the directional signal transceivers are different from on another. The processor is electrically connected to the directional signal transceivers, and configured to determine whether an intermediate communication device exists according to a wireless signal received by a part of the directional signal transceivers. When the intermediate communication device exists, the processor selects one of the directional signal transceivers for transmitting the apparatus information of the movable apparatus according to a position of the intermediate communication device.

### CROSS-REFERENCE TO RELATED APPLICATIONS

This non-provisional application claims priority under 35 U.S.C. § 119(a) on Patent Application No(s). 105140002 filed in Taiwan, R.O.C. on Dec. 2, 2016, the entire contents of which are hereby incorporated by reference.

### BACKGROUND

### Technical Field

This disclosure relates to a communication device, and more particularly to a communication device applied to a movable apparatus.

### Related Art

An in-vehicle computer with a function of communication is capable of automatically transmitting apparatus information of the movable apparatus such as a vehicle, in which the in-vehicle computer is installed, by a wireless signal, and is also capable of automatically receiving apparatus information of a nearby movable apparatus, in order to improve driving security. However, a conventional movable apparatus transmits the apparatus information omni-directionally so that if there are many movable apparatuses, the wireless signals of them will interfere with one another. Furthermore, for the omni-directional transmission of a wireless signal, most of the power consumption of an antenna is waste, and this situation does not match the trends of environment protection and energy conservation.

### SUMMARY

According to one or more embodiments of this disclosure, the communication device, suitable for being installed in a movable apparatus, includes a number of directional signal transceivers and a processor wherein aiming directions of the directional signal transceivers are different from on another. The processor is electrically connected to the directional signal transceivers, and configured to determine whether an intermediate communication device exists according to a wireless signal received by a part of the directional signal transceivers. When the intermediate communication device exists, the processor selects one of the directional signal transceivers for transmitting the apparatus information of the movable apparatus according to a position of the intermediate communication device.

According to one or more embodiments of this disclosure, a control method, applied to a communication device of a movable apparatus, includes the following steps: providing a number of directional signal transceivers wherein aiming directions of the directional signal transceivers are different from one another; determining whether an intermediate communication device exists according to a wireless signal received by a part of the directional signal transceivers; and when the intermediate communication device exists, selecting one of the directional signal transceivers for transmitting the apparatus information of the movable apparatus according to a position of the intermediate communication device.

### BRIEF DESCRIPTION OF THE DRAWINGS

FIG. 1 is a functional block diagram of a vehicular communication device in an embodiment of this disclosure;

FIG. 2 is a schematic diagram of a driving environment of a movable apparatus in an embodiment of this disclosure;

FIG. 3 is a schematic diagram of a driving environment of a movable apparatus in another embodiment of this disclosure; and

FIG. 4 is flow chart of a control method of a communication device in an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

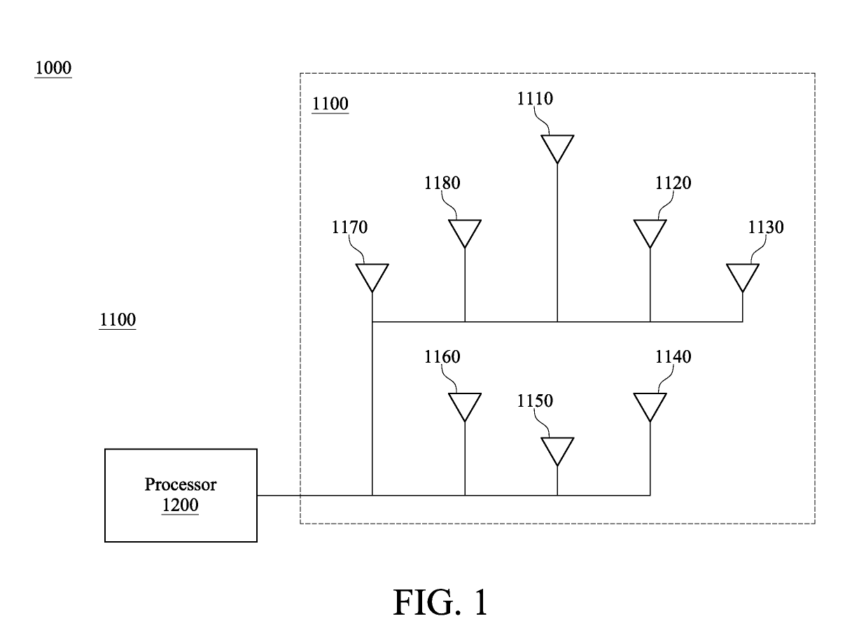

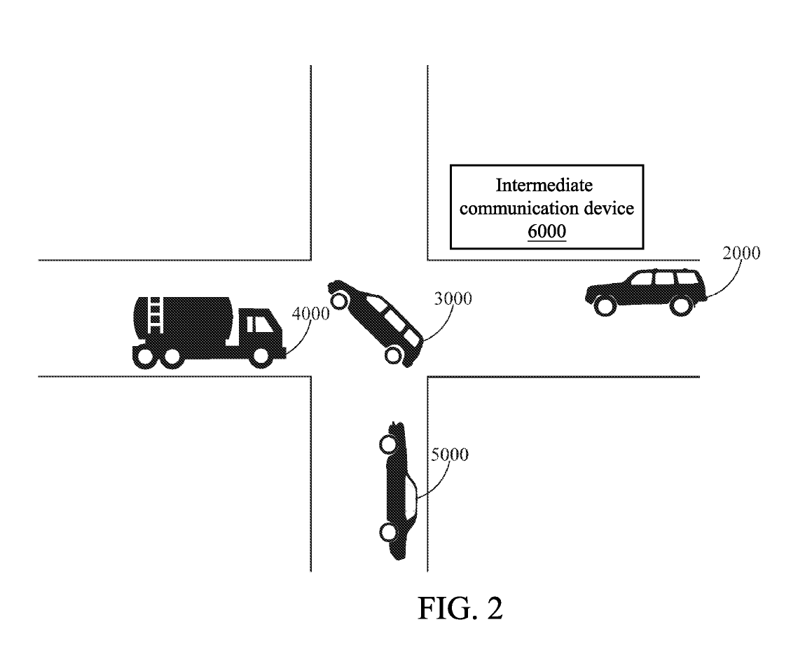

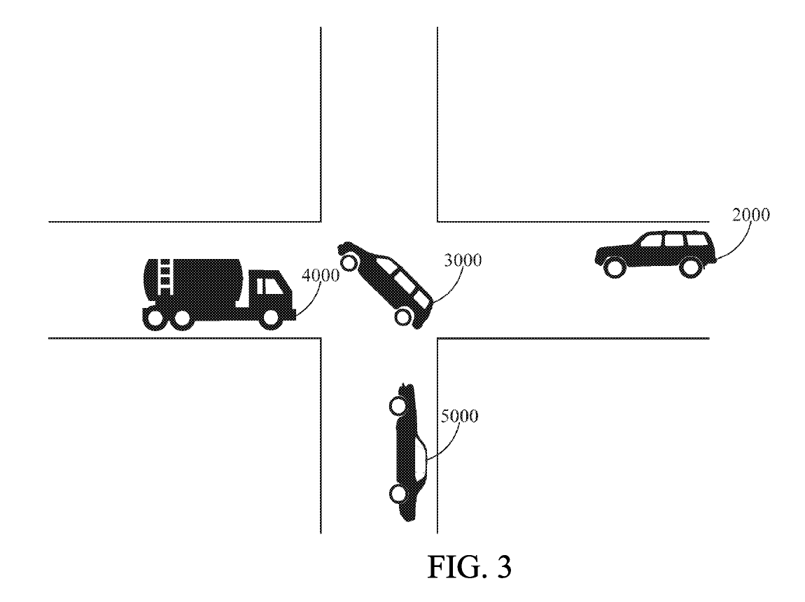

Please refer to FIG. 1, FIG. 2 and FIG. 3. FIG. 1 is a functional block diagram of a vehicular communication device in an embodiment of this disclosure; FIG. 2 is a schematic diagram of a driving environment of a movable apparatus in an embodiment of this disclosure; and FIG. 3 is a schematic diagram of a driving environment of a movable apparatus in another embodiment of this disclosure. As shown in FIG. 1, a communication device 1000 in an embodiment of this disclosure includes a signal transceiver array 1100 and a processor 1200. The signal transceiver array 1100 includes eight directional signal transceivers 1110-1180, and the directional signal transceivers have different directions therebetween. More concretely, each of the directional signal transceivers is a mono-pole antenna, which has the better ability to transmit and receive signals in a single direction but is weaker at transmitting and receiving signals in other directions. Moreover, in an embodiment, all the directional signal transceivers are on the same plane, which approximately parallels to a car roof (the road). The processor 1200 is electrically connected to the signal transceiver array 1100 to selectively use part of or all of the directional signal transceivers to transmit and receive signals. In one or more embodiments of this disclosure, each of the directional signal transceivers is, for example, a directional antenna or a directional optical communication device. The mentioned directional antenna is a single antenna component to generate a main wave beam, or includes a number of antenna components to generate a wave beam together. The mentioned directional optical communication device generates optical signals by a light emitting diode or a laser generator to transmit data, and captures optical signals by an optical receiver or an image capturing device to receive data. In one or more embodiments, the directional signal transceiver includes both the antenna and the optical communication device. The aforementioned movable apparatus is, for example, a vehicle, a motorcycle, a bike, a skateboard or other apparatus which can move on a road or a specific track, and is not limited in this disclosure.

In a driving environment as shown in FIG. 2, there are a movable apparatus 2000, a movable apparatus 3000, a movable apparatus 4000, a movable apparatus 5000 and an intermediate communication device 6000. The intermediate communication device 6000 is disposed at an intersection, and each movable apparatus has the communication device 1000 as shown in FIG. 1. In this environment, each movable apparatus transmit apparatus information in itself to the intermediate communication device 6000. For example, the apparatus information includes maintenance information, a global positioning system (GPS) coordinate, a moving direction and/or a moving rate. Moreover, the apparatus information can also be event information such as environment information, robbery information, and so on. The intermediate communication device 6000 packages at least part of the received apparatus information of the movable apparatus in auxiliary information and broadcasts the auxiliary information to all movable apparatuses in this environment. Therefore, if the movable apparatus is capable of wireless communication, the movable apparatus can obtain the apparatus information of the surrounding movable apparatus from the received apparatus information so that the in-vehicle computer of the movable apparatus may improve driving security. In a driving environment as shown in FIG. 3, there is no intermediate communication device 6000 so that the movable apparatus cannot to transmit the apparatus information in itself to the intermediate communication device 6000 as the embodiment shown in FIG. 2.

More concretely, in the embodiment as shown in FIG. 2, when the intermediate communication device 6000 broadcasts the auxiliary information, the intermediate communication device 6000 also broadcasts the GPS coordinate in itself. Therefore, when the communication device 1000 installed in the movable apparatus 2000 receives the auxiliary information via the signal transceiver array 1100, the communication device 1000 simultaneously obtains the position of the intermediate communication device 6000. Then, the processor 1200 determines which one or two directional signal transceivers have aiming directions almost (or even directly) aiming at the intermediate communication device 6000 according to the GPS coordinate of the movable apparatus 2000, the moving direction of the movable apparatus 2000 and the GPS coordinate of the intermediate communication device 6000. For example, the processor 1200 determines the directional signal transceiver 1130 directly faces the intermediate communication device 6000 so that the processor 1200 of the communication device 1000 of the movable apparatus 2000 selects the directional signal transceiver 1130 for transmitting apparatus information of the movable apparatus 2000. In an embodiment, at this moment, merely the directional signal transceivers 1130 is enabled to transmit the apparatus information but the others are disabled. In another embodiment, the processor 1200 determines the connecting line between the intermediate communication device 6000 and the movable apparatus 2000 just lies in between the aiming direction of the directional signal transceivers 1130 and that of the directional signal transceivers 1140 so that the processor 1200 selects the directional signal transceivers 1130 and the directional signal transceivers 1140 for simultaneously transmitting the apparatus information of the movable apparatus 2000. In another embodiment, an included angle is between the aiming direction of each of the directional signal transceiver and the connecting line, which is between the movable apparatus 2000 and the intermediate communication device 6000. The processor 1200 of the communication device 1000 of the movable apparatus 2000 selects the directional signal transceiver, corresponding to the smallest included angle, for transmitting the apparatus information of the movable apparatus 2000.

Similarly, in the embodiment as shown in FIG. 2, when the processor 1200 determines which one or more directional signal transceivers to transmit the apparatus information according to the position (GPS coordinate) of the intermediate communication device 6000, the processor 1200 determines which one or more directional signal transceivers to receive the auxiliary information from the intermediate communication device 6000 at the same time. In an embodiment, the directional signal transceiver which is selected by the processor 1200 for transmitting the apparatus information is same as the directional signal transceiver which is selected by the processor 1200 to receive the auxiliary information from the intermediate communication device 6000. In another embodiment, as aforementioned, when the processor 1200 selects the directional signal transceiver 1130 for transmitting the apparatus information, the processor 1200 selects the directional signal transceivers 1120 and 1140, which are both adjacent the directional signal transceivers 1130, for receiving the auxiliary information.

In an embodiment, when the processor 1200 of the communication device 1000 of the movable apparatus 2000 processes the auxiliary information and the auxiliary information does not include the apparatus information of the movable apparatus 2000, the processor 1200 determines that the intermediate communication device 6000 does not receive the apparatus information of the movable apparatus 2000 so that processor 1200 resends the apparatus information of the movable apparatus 2000 with the first period, 0.1 second for example. When the processor 1200 of the communication device 1000 of the movable apparatus 2000 processes the auxiliary information and the auxiliary information includes the apparatus information of the movable apparatus 2000, the processor 1200 determines that the intermediate communication device 6000 already receives the apparatus information of the movable apparatus 2000 so that the processor 1200 adjust the period of transmitting the apparatus information and resends the apparatus information of the movable apparatus 2000 with the adjusted period (the second period) of 0.5 second.

As shown in FIG. 3, when there is no intermediate communication device 6000 in the driving environment, the selection strategy for the directional signal transceiver of the processor 1200 of the communication device 1000 of the movable apparatus 2000 changes. In an embodiment, when the processor 1200 recognizes that the signal merely includes the apparatus information of one movable apparatus and no packet includes the apparatus information of a number of movable apparatuses as processing the signal received by the signal transceiver array 1100, the processor 1200 determines that no intermediate communication device is near the movable apparatus 2000. Then, the processor 1200 selects one of the directional signal transceivers for transmitting the apparatus information of the movable apparatus 2000 according to the moving direction of the movable apparatus 2000. In an embodiment, the processor 1200 determines the moving direction of the movable apparatus 2000 according to the steering angle of the steering wheel of the movable apparatus 2000. For example, when the steering angle of the steering wheel is equal to zero, the movable apparatus 2000 moves straight forward so that the processor 1200 selects the directional signal transceiver 1110 which has an aiming direction aiming right ahead the movable apparatus 2000 for transmitting the apparatus information. Under this condition, if the movable apparatus 2000 is braked or is in reverse gear, the processor 1200 select the directional signal transceiver 1150, which has an aiming direction aiming right behind the movable apparatus, for transmitting the apparatus information according to a brake signal or a reverse-gear signal, which indicates whether to shift into reverse, for example. As another example, when the steering angle indicates the steering wheel is turned right through a circle, the movable apparatus 2000 turns right, so that the processor 1200 selects the directional signal transceivers 1120, which has an aiming direction aiming at the right-front of the movable apparatus 2000, for transmitting the apparatus information. Under this condition, if the movable apparatus 2000 is braked, the processor 1200 selects the directional signal transceivers 1140, which has an aiming direction aiming at the right-rear of the movable apparatus 2000, for transmitting the apparatus information. In the aforementioned embodiment, the steering angle is obtained by the steering wheel. In another embodiment, the steering angle can also be obtained by a transmission system of the movable apparatus.

Furthermore, the processor 1200 is capable of determining the moving direction of the movable apparatus 2000 further according to the path information. The path information can be provided by the intermediate communication device 6000, a positioning system of the movable apparatus 2000 or a in-vehicle computer of the movable apparatus so that the processor 1200 selects the directional signal transceiver, which has a moving direction paralleling to the road, or has the smallest angle between a line along the road and a line along the moving direction of the movable apparatus, for transmitting the apparatus information.

In an embodiment, when the processor 1200 determines there is no intermediate communication device in the communication range, the processor 1200 determines which one or more directional signal transceivers to transmit the apparatus information further according to the position of the movable apparatus 2000. As mentioned before, each of the movable apparatus 3000, the movable apparatus 4000 and the movable apparatus 5000 also includes the communication device 1000. The communication device 1000 of the movable apparatus 3000 determines that the movable apparatus 3000 is at the intersection so that the processor 1200 of the communication device 1000 of the movable apparatus 3000 selects a number of directional signal transceivers for transmitting the apparatus information of the movable apparatus 3000 along each of roads from the intersection.

In yet another embodiment, the processor 1200 determines the period of transmitting apparatus information further according to the GPS coordinate (position) of the movable apparatus. For example, in FIG. 3, the movable apparatus 2000 and the movable apparatus 4000 are on a road, the movable apparatus 3000 is at the intersection, and the movable apparatus 5000 is on an alley. The communication devices installed in the movable apparatus 2000 and the movable apparatus 4000 transmit the apparatus information every 0.2 second. Because the movable apparatus 3000 is at the intersection of the main road and the alley, the communication device installed in the movable apparatus 3000 also transmits the apparatus information every 0.2 second. In contrast, the communication device installed in the movable apparatus 5000 transmits the apparatus information every 0.5 second.

In yet another embodiment as shown in FIG. 2 or FIG. 3, the processor 1200 determines the period of transmitting the apparatus information further according to the driving speed of the movable apparatus. In the embodiment as shown in FIG. 2, when the driving speed of the movable apparatus 2000 is 10 miles per hour (mph), the communication device 1000 of the movable apparatus 2000 transmits the apparatus information to the intermediate communication device 6000 every 1 second. When the driving speed of the movable apparatus 2000 is 20 mph, the communication device 1000 of the movable apparatus 2000 transmits the apparatus information to the intermediate communication device 6000 every 0.5 second. When the driving speed of the movable apparatus 2000 is 30 mph, the communication device 1000 of the movable apparatus 2000 transmits the apparatus information to the intermediate communication device 6000 every 0.2 second.

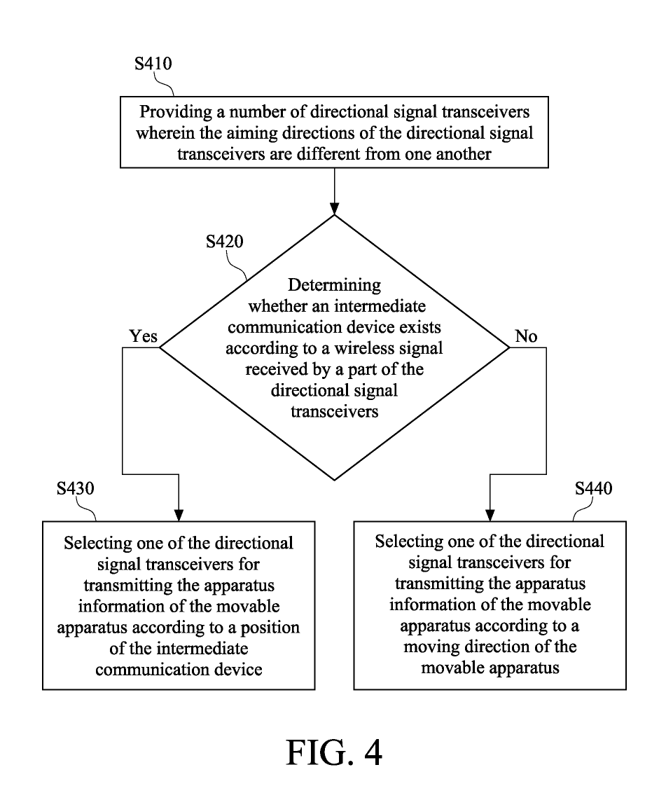

Therefore, a control method of the communication device according to the aforementioned embodiments is summarized in FIG. 4. FIG. 4 is flow chart of a control method of a communication device in an embodiment of this disclosure. In step S410, a number of directional signal transceivers are provided and the aiming directions of the directional signal transceivers are different from one another. In step S420, whether an intermediate communication device exists or not is determined according to a wireless signal received by a part of the directional signal transceivers. When the intermediate communication device exists, in step S430, one of the directional signal transceivers is selected for transmitting apparatus information of the movable apparatus according to a position of the intermediate communication device. In contrast, when the intermediate communication device does not exist, in step S440, one of the direction signal transceivers is selected for transmitting the apparatus information according to a moving direction of the movable apparatus.

In view of the above statement, the vehicular communication device and the control method thereof in this disclosure uses a number of directional signal transceivers and assign one of the directional signal transceivers for transmitting apparatus information. Therefore, transmitting the apparatus information by the vehicular communication device in this disclosure rather than the conventional omni-directional signal transceiver may save more electricity.

What is claimed is:

1. A communication device, installed in a movable apparatus, comprising:
a plurality of directional signal transceivers wherein aiming directions of the plurality of directional signal transceivers are different from one another; and
a processor electrically connected to the plurality of directional signal transceivers, and configured to determine whether an intermediate communication device exists according to a wireless signal received by a part of the plurality of directional signal transceivers, wherein when the intermediate communication device exists, the processor selects one of the plurality of directional signal transceivers for transmitting the apparatus information of the movable apparatus according to a position of the intermediate communication device.

2. The communication device according to claim 1, wherein when the intermediate communication device does not exist, the processor selects one of the plurality of directional signal transceivers for transmitting the apparatus information according to a moving direction of the movable apparatus.

3. The communication device according to claim 2, wherein the processor determines the moving direction according to a steering angle of the movable apparatus or path information.

4. The communication device according to claim 3, wherein the processor further selects one of the plurality of directional signal transceivers for transmitting the apparatus information according to a brake signal or a reverse-gear signal of the movable apparatus.

5. The communication device according to claim 3, wherein the movable apparatus is a vehicle, and the steering angle of the movable apparatus is obtained by a steering wheel or a transmission system of the vehicle.

6. The communication device according to claim 3, wherein the path information is obtained by a positioning system of the movable apparatus.

7. The communication device according to claim 1, wherein when the intermediate communication device exists, the processor further selects a part of the plurality of directional signal transceivers for receiving auxiliary information transmitted by the intermediate communication device according to a position of the intermediate communication device.

8. The communication device according to claim 1, wherein when the intermediate communication device exists, the processor further adjusts a period of transmitting the apparatus information according to auxiliary information transmitted by the intermediate communication device.

9. The communication device according to claim 8, wherein the processor adjusts the period of transmitting the apparatus information according to whether the auxiliary information comprises the apparatus information.

10. A control method of a communication device, applied to a movable apparatus which comprises a plurality of directional signal transceivers, wherein aiming directions of the plurality of directional signal transceivers are different from one another, and the control method comprises:
determining whether an intermediate communication device exists according to a wireless signal received by a part of the plurality of directional signal transceivers; and
when the intermediate communication device exists, selecting one of the plurality of directional signal transceivers for transmitting the apparatus information of the movable apparatus according to a position of the intermediate communication device.

11. The control method according to claim 10, further comprising:
when the intermediate communication device does not exist, selecting one of the plurality of directional signal transceivers for transmitting the apparatus information according to a moving direction of the movable apparatus.

12. The control method according to claim 11, wherein the moving direction is determined according to a steering angle of the movable apparatus or path information.

13. The control method according to claim 12, wherein one of the plurality of directional signal transceivers is selected for transmitting the apparatus information according to a brake signal or a reverse-gear signal of the movable apparatus.

14. The control method according to claim 12, wherein the movable apparatus is a vehicle, and the control method further comprises obtaining the steering angle of the movable apparatus by a steering wheel or a transmission system of the vehicle.

15. The control method according to claim 12, further comprising obtaining the path information by a positioning system of the movable apparatus.

16. The control method according to claim 10, wherein when the intermediate communication device exists, the control method further comprises:
selecting a part of the plurality of directional signal transceivers for receiving auxiliary information transmitted by the intermediate communication device according to a position of the intermediate communication device.

17. The control method according to claim 10, wherein when the intermediate communication device exists, the control method further comprises:
adjusting a period of transmitting the apparatus information according to auxiliary information transmitted by the intermediate communication device.

18. The control method according to claim 17, wherein the period of the apparatus information is adjusted according to whether the auxiliary information comprises the apparatus information.
